(19) United States
(12) Patent Application Publication
(10) Pub. No.: US 2026/0237151 A1
(43) Pub. Date: Aug. 13, 2026

(54) SIGNAL PROPAGATION MODELING BASED ON ONE OR MORE 2D REPRESENTATIONS OF AN ENVIRONMENT

(71) Applicant: Ekahau, Inc., New York, NY (US)

(72) Inventors: Vladimir Abramov, Espoo (FI); Olli Alanen, Helsinki (FI)

(21) Appl. No.: 19/048,024

(22) Filed: Feb. 7, 2025

(51) Int. Cl. G06T 17/00; G06T 7/13; G06T 7/60; G06T 19/20; G06V 10/764; H04B 17/391

(52) U.S. Cl. CPC G06T 17/00; G06T 7/13; G06T 7/60; G06T 19/20; H04B 17/3912; G06T 2200/24; G06T 2207/20092; G06T 2210/04; G06T 2219/2004; G06T 2219/2016; G06V 10/764

(57) ABSTRACT

The devices, systems, and methods described herein are directed to receiving one or more two-dimensional representations of an environment and defining a boundary of a first area of a first level of the environment in which there is at least one feature having a height that is different than a base height of the first level. In some examples, the first area is converted into one or more sub-levels that each have a sub-level height that differs from the base height. Next, a three-dimensional model of the environment comprising at least the first level and the one or more sub-levels is generated. In further examples, a signal propagation model of the environment, based on the three-dimensional model, is generated. In still further examples, the signal propagation model is displayed to a user.

### FIELD

The subject matter described herein relates to signal propagation modeling and more particularly to signal propagation modeling based on one or more two-dimensional representations of an environment.

### BACKGROUND

Wi-Fi is a family of wireless network protocols based on the Institute of Electrical and Electronics Engineers (IEEE) 802.11 family of standards, which are commonly used for local area networking of devices and Internet access, allowing nearby digital devices to exchange data via radio waves. Wi-Fi networks are some of the most widely used computer networks in the world, used globally in home and small office networks to link devices together and to connect them to the Internet via a wireless router. Wi-Fi networks often use wireless access points in public places like coffee shops, hotels, libraries, and airports to provide visitors with Internet connectivity for their mobile devices. In some instances, the Wi-Fi networks are located in complex three-dimensional environments that make it difficult to predict the manner in which signals may propagate throughout the environment.

### SUMMARY

The devices, systems, and methods described herein are directed to receiving one or more two-dimensional representations of an environment and defining a boundary of a first area of a first level of the environment in which there is at least one feature having a height that is different than a base height of the first level. In some examples, the first area is converted into one or more sub-levels that each have a sub-level height that differs from the base height. Next, a three-dimensional model of the environment comprising at least the first level and the one or more sub-levels is generated. In further examples, a signal propagation model of the environment, based on the three-dimensional model, is generated. In still further examples, the signal propagation model is displayed to a user.

### BRIEF DESCRIPTION OF THE DRAWINGS

FIG. 1 is a block diagram of an example of a system for performing signal propagation modeling from one or more two-dimensional representations of an environment.

FIG. 2A is an example of a two-dimensional representation of a first level of an environment that has a defined boundary of a first area of the first level in which there is at least one feature having a height that is different than a base height of the first level.

FIG. 2B is an example of a three-dimensional model of the environment generated after converting the first area of the example shown in FIG. 2A into one or more sub-levels that each have a sub-level height that differs from the base height of the first level.

FIG. 3A is an example of multiple two-dimensional representations of an environment being correctly positioned relative to each other before generating the three-dimensional model of the environment, which includes each level and one or more sub-levels located between each level.

FIG. 3B is an example of a three-dimensional model of the environment generated from the example shown in FIG. 3A.

FIG. 4 is an example of a feature on a two-dimensional representation of an environment that corresponds with a known object type and has been utilized to generate a sub-level that corresponds with the known object type.

FIG. 5 is a flow chart of a first example of a method for performing signal propagation modeling from two or more two-dimensional representations of an environment.

### DETAILED DESCRIPTION

Since Wi-Fi networks are very widely deployed in different environments, it is desirable to simplify the initial setup of wireless networks and the optimization of existing wireless networks, particularly in complex three-dimensional (3D) environments. Examples of a complex 3D environment include: cruise ships, stadiums, auditoriums, theaters, business buildings having an atrium, and outdoor environments having unique topographical features, etc. In order to generate signal propagation models of these environments, a 3D model of the environment must first be generated.

However, currently existing 3D modeling solutions are based on complex modeling interactions involving multiple parameter definitions. These solutions are unnecessarily complicated and require a high degree of user knowledge and experience with 3D modeling software to implement. It would be advantageous for an inexperienced user to be able to quickly and easily model and approximate complex 3D environments so that signal propagation modeling of the 3D environment can be performed.

The examples described below generally involve manipulating two-dimensional (2D) representations (e.g., images) of an environment to form 3D structure without the need to specify actual 3D shapes and parameters. These examples allow for a much faster and simpler definition process as well as automation of many parts of the 3D environment definitions. In this way, the examples create a new way of defining complex 3D environments based on flat floor maps or other 2D representations so that radio frequency (RF) signal propagation modeling can be performed on the 3D environment. These examples simplify and expedite the modeling process while still yielding an accurate signal propagation model of the environment.

The devices, systems, and methods described herein are directed to receiving one or more two-dimensional representations of an environment and defining a boundary of a first area of a first level of the environment in which there is at least one feature having a height that is different than a base height of the first level. In some examples, the first area is converted into one or more sub-levels that each have a sub-level height that differs from the base height. Next, a three-dimensional model of the environment comprising at least the first level and the one or more sub-levels is generated. In further examples, a signal propagation model of the environment, based on the three-dimensional model, is generated. In still further examples, the signal propagation model is displayed to a user.

Although the different examples of devices, systems, and methods may be described herein separately, any of the features of any of the examples may be added to, omitted from, or combined with any other example. Similarly, any of the features of any of the examples may be performed in parallel or performed in a different manner/order than that described or shown herein.

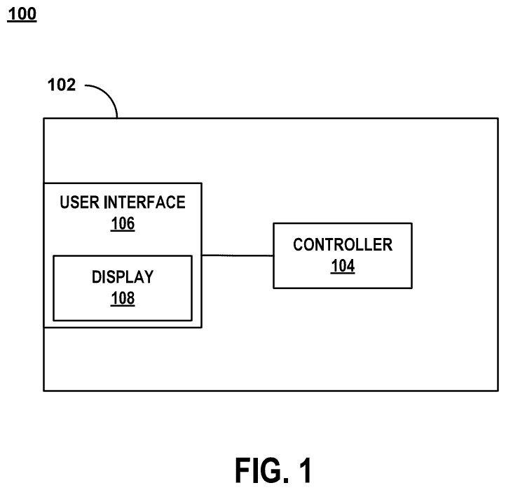

FIG. 1 is a block diagram of an example of a system for performing signal propagation modeling from one or more two-dimensional representations of an environment. In the example shown in FIG. 1, system 100 includes computing device 102. In some examples, computing device 102 can be any on-site computing device that can receive and process data associated with an environment to be modeled. For example, computing device 102 could be a tablet computer, a laptop computer, a smartphone, or a desktop computer. In other examples, any other suitable computing device, even a remote, off-site computing device, could be used to perform the functions described herein. In examples in which the computing device is off-site or remote, system 100 would further include suitable components, circuitry, and a communication interface to transmit data to and receive data from the off-site or remote computing device.

Computing device 102 includes controller 104 and user interface 106. Controller 104 includes any combination of hardware, software, and/or firmware for executing the functions described herein. An example of a suitable controller 104 includes software code running on a microprocessor or processor arrangement connected to memory (not explicitly shown).

In some examples, computing device 102 receives data (e.g., two-dimensional representations) from a user via user interface 106. In the example shown in FIG. 1, user interface 106 includes display 108 and one or more input mechanisms (not explicitly shown) that allow a user to enter information, make selections, and otherwise interact with visual elements displayed on display 108. In some examples, the input mechanisms may include a touchscreen associated with display 108, a keyboard, touchpad, mouse, microphone, etc. In other examples, a user may utilize any suitable method of uploading or transferring relevant data/files to computing device 102 to facilitate the modeling process, including wired or wireless transmissions, data ports, etc.

Display 108 is used to present information to a user regarding various stages of the modeling process, as well as the final signal propagation model of an environment. As will be discussed more fully below, display 108 and the associated input mechanisms can be used to obtain a variety of inputs from a user to facilitate the modeling process.

In operation, controller 104 receives a first two-dimensional representation of a first level of an environment to be modeled. The first level of the environment has a base height. In some examples, controller 104 also receives a second two-dimensional representation of a second level of the environment. In further examples, additional two-dimensional representations of the environment may be received by controller 104. In some examples, each two-dimensional representation is a floor plan of a separate floor (e.g., level) of an environment (e.g., building, stadium, etc.). In other examples, controller 104 may receive a number of two-dimensional representations that is less than the total number of levels of an environment. For example, if a user only wants to model the lowest two levels of an environment that has five levels, the user may only enter floor plans for the lowest two levels.

In the example shown in FIG. 1, user interface 106, which is coupled to controller 104, receives, from a user, first and second two-dimensional representations that represent the environment. In some examples, controller 104 correctly positions the second two-dimensional representation relative to the first two-dimensional representation. In some of these examples, controller 104 automatically orders the first two-dimensional representation and the second two-dimensional representation from bottom to top. In other examples, controller 104 automatically resizes a scale of the second two-dimensional representation to match a scale of the first two-dimensional representation. In still further examples, controller 104 automatically aligns the second two-dimensional representation in x, y, and z directions with the first two-dimensional representation. In examples in which there are more than two two-dimensional representations of the environment, controller 104 can correctly position all of the two-dimensional representations relative to each other, in any of the manners described above.

In the example shown in FIG. 1, controller 104 also defines a boundary of a first area of the first level in which there is at least one feature having a height that is different than the base height of the first level. In some examples, controller 104 converts the first area into one or more sub-levels that each have a sub-level height that differs from the base height. In some examples, the difference between the base height and the one or more sub-level heights is a discrete change in height. An example of a discrete change in height would be when the sub-level heights each correspond with the height of a particular stair or ledge (or other feature) that has a distinct height relative to the base height. In other examples, the difference between the base height and the one or more sub-level heights is a sloped change in height. An example of a sloped change in height would be when a sub-level height corresponds with a gradual change in height of a sloped feature (e.g., upward sloping floor of a theater or auditorium) relative to the base height. In further examples, a feature that may have one or more discrete changes in height relative to the base height (e.g., a flight of stairs) may be represented by a sloped change in height (e.g., a ramp) if the system determines that such a representation still provides a suitable representation of the three-dimensional environment for signal propagation modeling purposes.

In some examples, user interface 106 receives, from the user, an input that defines the boundary of the first area of the first two-dimensional representation. In other examples, controller 104 automatically analyzes the first two-dimensional representation and detects at least one feature that corresponds with a known object type. In these examples, controller 104, upon detecting that at least one feature corresponds with a known object type, automatically defines the boundary of the first area to include the feature that corresponds with a known object type. In further examples, controller 104 automatically defines at least one sub-level height of the one or more sub-levels as a height that corresponds with the known object type. In other examples, user interface 106 receives, from the user, an input that defines the sub-level height of the one or more sub-levels.

Once the first area is converted into sub-levels, controller 104 generates a three-dimensional model of the environment comprising the first level and the one or more sub-levels, in some examples. In other examples, the three-dimensional model comprises the first level, the one or more sub-levels, and the second level. Of course, in further examples having additional levels (and sub-levels), controller 104 may generate a three-dimensional model comprising all of the levels and the one or more sub-levels that may be located between each level. In still further examples, the user may submit an input, via user interface 106, indicating a portion of the environment for which the three-dimensional model should be generated that is less than the entire environment.

Once the three-dimensional model is generated, controller 104 generates a signal propagation model of the environment, based on the three-dimensional model, in some examples. Display 108 is used to display the signal propagation model to a user.

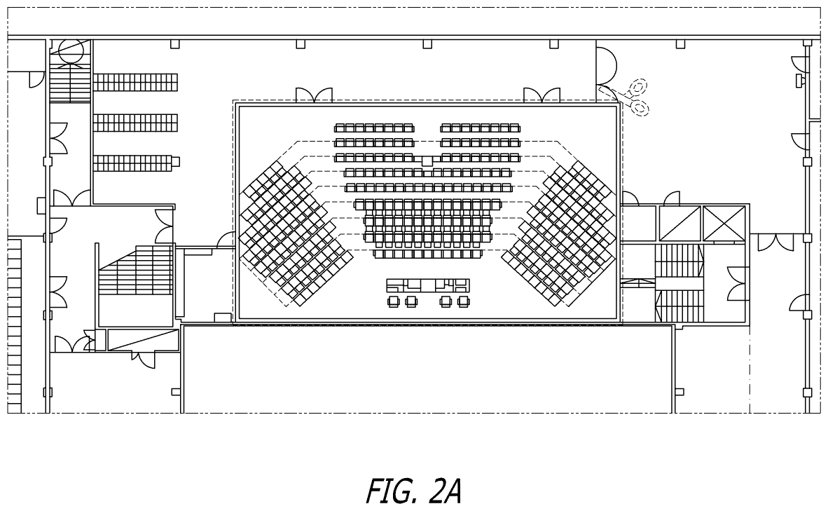

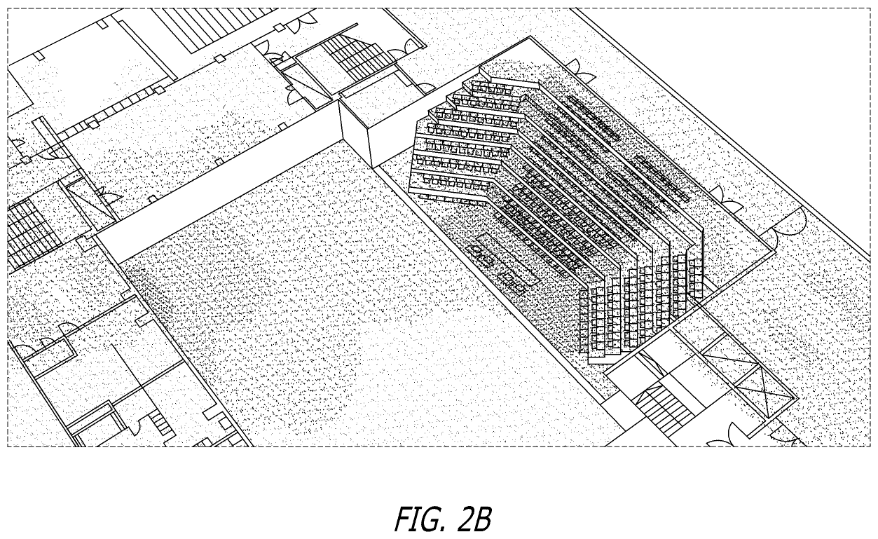

As mentioned above, a user may define, in some examples, a boundary of a first area of the first level in which there is at least one feature having a height that is different than a base height of the first level. FIG. 2A shows an example of a two-dimensional representation of a first level of an environment that has a defined boundary of a first area of the first level in which there is at least one feature having a height that is different than a base height of the first level. More specifically, FIG. 2A shows an environment that has multiple rows of tiered seats. In some examples, user interface 106 has a tool that allows the user to define the boundary of the first area. In the example shown in FIG. 2A, the tool is represented by a scissor icon.

The boundary of the first area shown in FIG. 2A is the outer perimeter of the area surrounded by a dashed line, which has been created by the user. In the example shown in FIG. 2A, the user has defined eight additional lines that designate the boundaries of other sub-levels (e.g., each row of seats) located within the first area, each sub-level having a sub-level height that is different than the base height of the first level. In this example, the base height of the first level would be the lowest point in the first area in front of the tiered seats. In some examples, the user may also input a sub-level height for each of the sub-levels (e.g., each row of seats). Although the user defines the boundary of the first area and the boundary of each of the sub-levels within the first area in this example, system 100 may automatically define the boundary of the first area and/or the boundaries of the sub-levels located within the first area, in other examples.

Once the first area of FIG. 2A has been converted into one or more sub-levels (e.g., each row of seats) that each have a sub-level height that differs from the base height, system 100 generates a three-dimensional model of the environment comprising the first level and the one or more sub-levels. System 100 then generates a signal propagation model of the environment, based on the three-dimensional model. FIG. 2B shows an example of a three-dimensional model of the environment generated after converting the first area of the example shown in FIG. 2A into one or more sub-levels that each have a sub-level height that differs from the base height of the first level. Besides showing the three-dimensional model of the environment, the shading in FIG. 2B represents the signal propagation model of the environment, which is reflected by darker areas of shading representing stronger signal propagation areas relative to the areas of the environment with lighter shading.

As described above, the systems disclosed herein allow a user to manually designate areas that have one or more features that have a different height than a base height of a particular level, in some examples. In other examples, the system can automatically detect which areas have one or more features that have a different height than a base height of a particular level. Regardless of how the areas are designated, the features with different heights (e.g., sub-level heights) can be altered in any suitable manner (e.g., bent, lifted, raised, lowered, or removed). Examples of such features include: atrium openings, staircases, auditoriums, theaters, or unnecessary image parts.

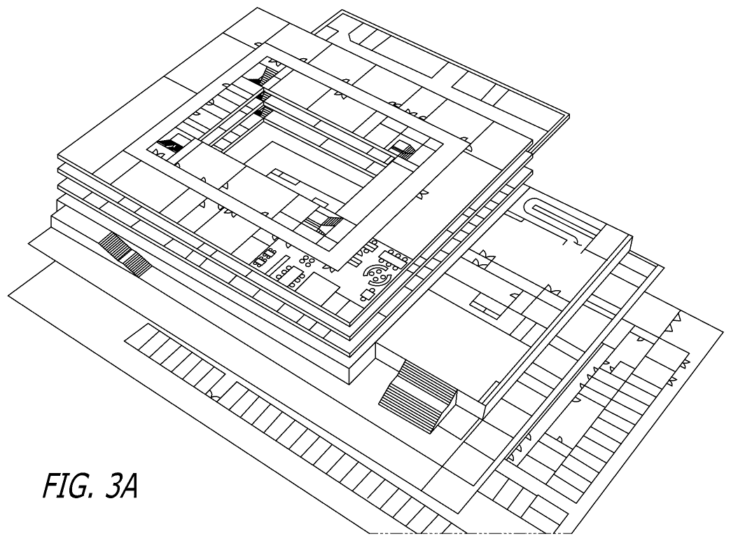

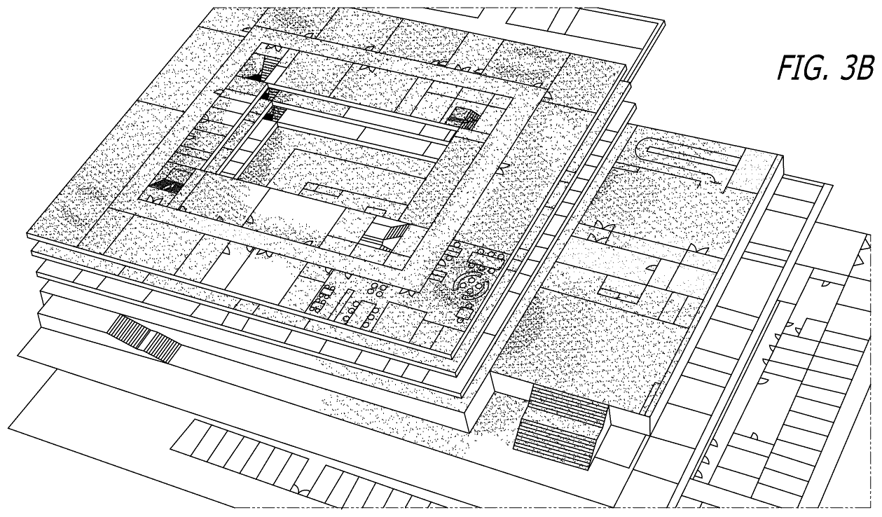

FIG. 3A shows an example of a more complex environment having multiple levels and an opening (e.g., atrium) that extends through the upper levels of the environment. More specifically, FIG. 3A shows multiple two-dimensional representations of an environment being correctly positioned relative to each other before generating the three-dimensional model of the environment, which includes each level and one or more sub-levels located between each level. FIG. 3B is an example of a three-dimensional model of the environment generated from the example shown in FIG. 3A. Besides showing the three-dimensional model of the environment, the shading in FIG. 3B represents the signal propagation model of the environment, which is reflected by darker areas of shading representing stronger signal propagation areas relative to the areas of the environment with lighter shading.

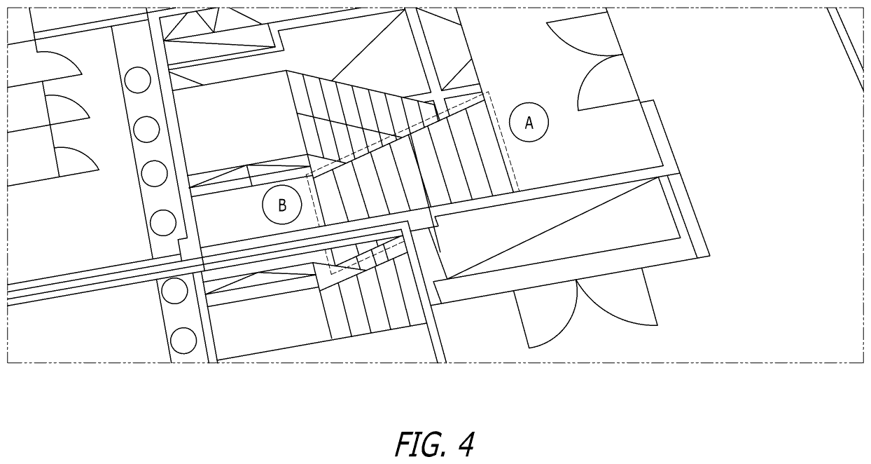

In further examples, a user can define which levels (or sub-levels) to which a particular feature is connected, and the system will automatically align/position the feature between the two levels (or sub-levels). An example of this functionality is shown within the context of FIG. 4. More specifically, FIG. 4 is an example of a feature on a two-dimensional representation of an environment that corresponds with a known object type (e.g., a flight of stairs) and has been utilized to generate at least one sub-level that corresponds with the known object type. For example, in FIG. 4, a user could specify that the uppermost stair of a flight of stairs is connected to level “A” and that the bottommost stair of the flight of stairs is connected to level “B” (or sub-level “B” if the flight of stairs does not extend down to the next lower level). Thus, in this example, the system would automatically align the designated flight of stairs between the two specified levels (or sub-levels). In other examples, the system could automatically detect the flight of stairs and align/position the designated flight of stairs between the correct two levels (or sub-levels) without user input.

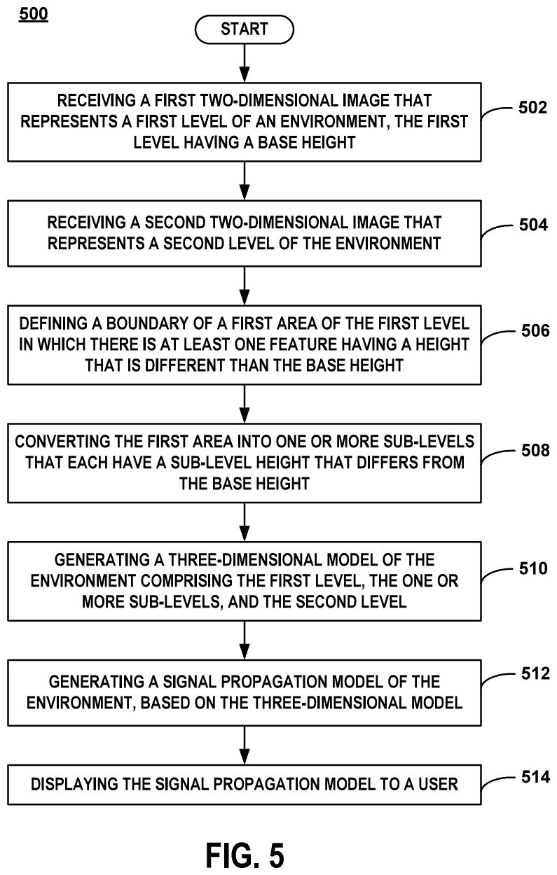

FIG. 5 is a flow chart of an example of a method for performing signal propagation modeling from two or more two-dimensional representations of an environment. The method 500 begins at step 502 with receiving a first two-dimensional representation of a first level of an environment, where the first level has a base height. At step 504, the method continues with receiving a second two-dimensional representation of a second level of the environment. At step 506, the method further includes defining a boundary of a first area of the first level in which there is at least one feature having a height that is different than the base height. At step 508, the method also includes converting the first area into one or more sub-levels that each have a sub-level height that differs from the base height. At step 510, the method additionally includes generating a three-dimensional model of the environment comprising the first level, the one or more sub-levels, and the second level. At step 512, the method continues with generating a signal propagation model of the environment, based on the three-dimensional model. At step 514, the method further includes displaying the signal propagation model to a user.

In other examples, one or more of the steps of method 500 may be omitted, combined, performed in parallel, or performed in a different order than that described herein or shown in FIG. 5. In still further examples, additional steps may be added to method 500 that are not explicitly described in connection with the example shown in FIG. 5. For example, in other examples, method 500 may additionally include correctly positioning the second two-dimensional representation relative to the first two-dimensional representation. In further examples, method 500 may also include receiving, from the user, an input that defines the boundary of the first area of the first two-dimensional representation. In still further examples, method 500 additionally includes receiving, from the user, an input that defines the one or more sub-level heights.

In some examples, method 500 includes analyzing the first two-dimensional representation and detecting at least one feature that corresponds with a known object type. In these examples, method 500 may also include defining the boundary of the first area to include the at least one feature, upon detecting that the at least one feature corresponds with the known object type. In further examples, method 500 may additionally include defining at least one sub-level height of the one or more sub-levels as a height that corresponds with the known object type.

Clearly, other examples and modifications of the foregoing will occur readily to those of ordinary skill in the art in view of these teachings. The above description is illustrative and not restrictive. The examples described herein are only to be limited by the following claims, which include all such examples and modifications when viewed in conjunction with the above specification and accompanying drawings. The scope of the foregoing should, therefore, be determined not with reference to the above description alone, but instead should be determined with reference to the appended claims along with their full scope of equivalents.

What is claimed is:

1. A system for performing signal propagation modeling from two or more two-dimensional representations of an environment, the system comprising:
a controller to:
receive a first two-dimensional representation of a first level of an environment, the first level having a base height,
receive a second two-dimensional representation of a second level of the environment,
define a boundary of a first area of the first level in which there is at least one feature having a height that is different than the base height,
convert the first area into one or more sub-levels that each have a sub-level height that differs from the base height,
generate a three-dimensional model of the environment comprising the first level, the one or more sub-levels, and the second level, and
generate a signal propagation model of the environment, based on the three-dimensional model; and
a display to display the signal propagation model to a user.

2. The system of claim 1, wherein the controller correctly positions the second two-dimensional representation relative to the first two-dimensional representation.

3. The system of claim 2, wherein the controller automatically orders the first two-dimensional representation and the second two-dimensional representation from bottom to top.

4. The system of claim 2, wherein the controller automatically resizes a scale of the second two-dimensional representation to match a scale of the first two-dimensional representation.

5. The system of claim 2, wherein the controller automatically aligns the second two-dimensional representation in x, y, and z directions with the first two-dimensional representation.

6. The system of claim 1, further comprising a user interface coupled to the controller, the user interface to receive, from the user, the first and second two-dimensional representations that represent the environment.

7. The system of claim 6, wherein the user interface further receives, from the user, an input that defines the boundary of the first area of the first two-dimensional representation.

8. The system of claim 6, wherein the user interface further receives, from the user, an input that defines the sub-level height of the one or more sub-levels.

9. The system of claim 1, wherein the controller automatically analyzes the first two-dimensional representation and detects that the at least one feature corresponds with a known object type.

10. The system of claim 9, wherein the controller, upon detecting that the at least one feature corresponds with the known object type, automatically defines the boundary of the first area to include the at least one feature.

11. The system of claim 10, wherein the controller automatically defines at least one sub-level height of the one or more sub-levels as a height that corresponds with the known object type.

12. The system of claim 1, wherein the difference between the base height and the one or more sub-level heights is a discrete change in height.

13. The system of claim 1, wherein the difference between the base height and the one or more sub-level heights is a sloped change in height.

14. A method of performing signal propagation modeling from two or more two-dimensional representations of an environment, the method comprising:
receiving a first two-dimensional representation of a first level of an environment, the first level having a base height;
receiving a second two-dimensional representation of a second level of the environment;
defining a boundary of a first area of the first level in which there is at least one feature having a height that is different than the base height;
converting the first area into one or more sub-levels that each have a sub-level height that differs from the base height;
generating a three-dimensional model of the environment comprising the first level, the one or more sub-levels, and the second level;
generating a signal propagation model of the environment, based on the three-dimensional model; and
displaying the signal propagation model to a user.

15. The method of claim 14, further comprising:
correctly positioning the second two-dimensional representation relative to the first two-dimensional representation.

16. The method of claim 14, further comprising:
receiving, from the user, an input that defines the boundary of the first area of the first two-dimensional representation.

17. The method of claim 14, further comprising:
receiving, from the user, an input that defines the one or more sub-level heights.

18. The method of claim 14, further comprising:
analyzing the first two-dimensional representation; and
detecting that the at least one feature corresponds with a known object type.

19. The method of claim 18, further comprising:
upon detecting that the at least one feature corresponds with the known object type, defining the boundary of the first area to include the at least one feature.

20. The method of claim 19, further comprising:
defining at least one sub-level height of the one or more sub-levels as a height that corresponds with the known object type.
